(19) United States
(12) Patent Application Publication
(10) Pub. No.: US 2023/0003003 A1
(43) Pub. Date: Jan. 5, 2023

(54) SYSTEM AND METHOD FOR CONTROLLING TRANSPORT VEHICLE

(71) Applicant: KOMATSU LTD., Tokyo (JP)

(72) Inventors: Kenjiro SHIMADA, Tokyo (JP); Ayumi OHKUMA, Tokyo (JP); Aaron LELOUVIER, Tokyo (JP); Paulo MORALES, Tokyo (JP); Kazuhiko HAYASHI, Tokyo (JP)

(21) Appl. No.: 17/781,071

(22) PCT Filed: Mar. 4, 2021
(86) PCT No.: PCT/JP2021/008450

§ 371 Date: May 31, 2022

(30) Foreign Application Priority Data
Mar. 10, 2020 (JP) 2020-040660

(51) Int. Cl. E02F 9/20; G05D 1/02

(52) U.S. Cl. CPC E02F 9/2054; G05D 1/0212; E02F 9/205; G05D 2201/0202

(57) ABSTRACT

A controller acquires a static path indicative of a target route of a transport vehicle. The static path includes a first endpoint and a second endpoint. The static path is set between a first work machine and a second work machine. The controller determines a first dynamic path that connects the first endpoint and a first target position for work of the first work machine. The controller determines a second dynamic path that connects the second endpoint and a second target position for work of the second work machine. The controller controls the transport vehicle so that the transport vehicle travels according to the static path, the first dynamic path, and the second dynamic path.

### CROSS-REFERENCE TO RELATED APPLICATIONS

This application is a U.S. National stage application of International Application No. PCT/JP2021/008450, filed on Mar. 4, 2021. This U.S. National stage application claims priority under 35 U.S.C. § 119(a) to Japanese Patent Application No. 2020-040660, filed in Japan on Mar. 10, 2020, the entire contents of which are hereby incorporated herein by reference.

### BACKGROUND

The present invention relates to a system and a method for controlling a transport vehicle that transports materials between a first work machine and a second work machine.

### BACKGROUND INFORMATION

There is work which involves digging materials, such as soil and the like, by a work machine, such as a hydraulic excavator, and loading the materials onto a transport vehicle, such as a dump truck. The transport vehicle is loaded with the materials at a predetermined loading position. The transport vehicle travels to a predetermined dumping position and dumps the materials at the dumping position. The dumped materials are spread and leveled by a work machine, such as a bulldozer. The transport vehicle then returns to the loading position from the dumping position and materials are loaded again by the work machine onto the transport vehicle. Conventionally, as described in International Publication No. 2016/167374, a technique for performing the above transport work by the transport vehicle with automatic control is known. In International Publication No. 2016/167374, a controller, such as a processer, determines a target route of the transport vehicle.

### SUMMARY

A hydraulic excavator moves while digging. Also, a bulldozer moves while spreading and leveling the materials. Accordingly, the target route of the transport vehicle changes according to the work conditions of these work machines. Therefore, it is not easy to determine the optimal target route. Also, in order to determine the optimal target route, the load on the controller increases. An object of the present disclosure is to determine the optimal target route of the transport vehicle.

### SOLUTION TO PROBLEM

A system according to one aspect of the present disclosure is a system for controlling a transport vehicle that transports materials between a first work machine and a second work machine. The system includes a storage device and a controller. The controller is connected to the storage device. The controller acquires a static path indicative of a target route of the transport vehicle. The static path includes a first endpoint and a second endpoint. The static path is set between the first work machine and the second work machine.

The controller acquires a first target position for work of the first work machine. The controller determines a first dynamic path that connects the first endpoint and the first target position. The controller acquires a second target position for work of the second work machine. The controller determines a second dynamic path that connects the second endpoint and the second target position. The controller controls the transport vehicle so that the transport vehicle travels according to the static path, the first dynamic path, and the second dynamic path.

A method according to another aspect of the present disclosure is a method executed by a controller for controlling a transport vehicle that transports materials between a first work machine and a second work machine. The method includes the following processes. A first process is to acquire a static path indicative of a target route of the transport vehicle. The static path includes a first endpoint and a second endpoint. The static path is set between the first work machine and the second work machine.

A second process is to acquire a first target position for work of the first work machine. A third process is to determine a first dynamic path that connects the first endpoint and the first target position. A fourth process is to acquire a second target position for work of the second work machine. A fifth process is to determine a second dynamic path that connects the second endpoint and the second target position. A sixth process is to control the transport vehicle so that the transport vehicle travels according to the static path, the first dynamic path, and the second dynamic path. The execution order of the processes is not limited to the above-mentioned order and may be changed.

According to the present disclosure, the first dynamic path is determined according to the first target position for the work of the first work machine. The second dynamic path is determined according to the second target position for the work of the second work machine. Accordingly, the optimal travel route of the transport vehicle can be determined.

### BRIEF DESCRIPTION OF DRAWINGS

FIG. 1 is a plan view illustrating an example of a work site where a work machine is used.

FIG. 2 is a side view of a transport vehicle.

FIG. 3 is a side view of a first work machine.

FIG. 4 is a side view of a second work machine.

FIG. 5 is a block diagram illustrating a configuration of the transport vehicle.

FIG. 6 is a flowchart illustrating processes of automatic control of the transport vehicle.

FIG. 7 is a plan view schematically illustrating a method for determining a travel path in an automatic control mode including a static path.

FIG. 8 is a plan view schematically illustrating a method for determining the travel path in the automatic control mode including first, second and third paths associated with the static path.

FIG. 9 is a front view of the transport vehicle.

FIG. 10 is a plan view schematically illustrating the method for determining the travel path in the automatic control mode including a first target position in a first work area.

FIG. 11 is a plan view schematically illustrating the method for determining the travel path in the automatic control mode including a first dynamic path.

FIG. 12 is a plan view schematically illustrating the method for determining the travel path in the automatic control mode including a plurality of second target positions.

FIG. 13 is a plan view schematically illustrating the method for determining the travel path in the automatic control mode including a second dynamic path.

FIG. 14 is a plan view schematically illustrating the traveling of the transport vehicle in the automatic control mode from the first target position.

FIG. 15 is a plan view schematically illustrating the traveling of the transport vehicle in the automatic control mode from the second endpoint of the static path.

FIG. 16 is a plan view schematically illustrating the traveling of the transport vehicle in the automatic control mode from the second target position.

FIG. 17 is a plan view schematically illustrating the traveling of the transport vehicle in the automatic control mode from the first endpoint of the static path.

### DESCRIPTION OF EMBODIMENTS

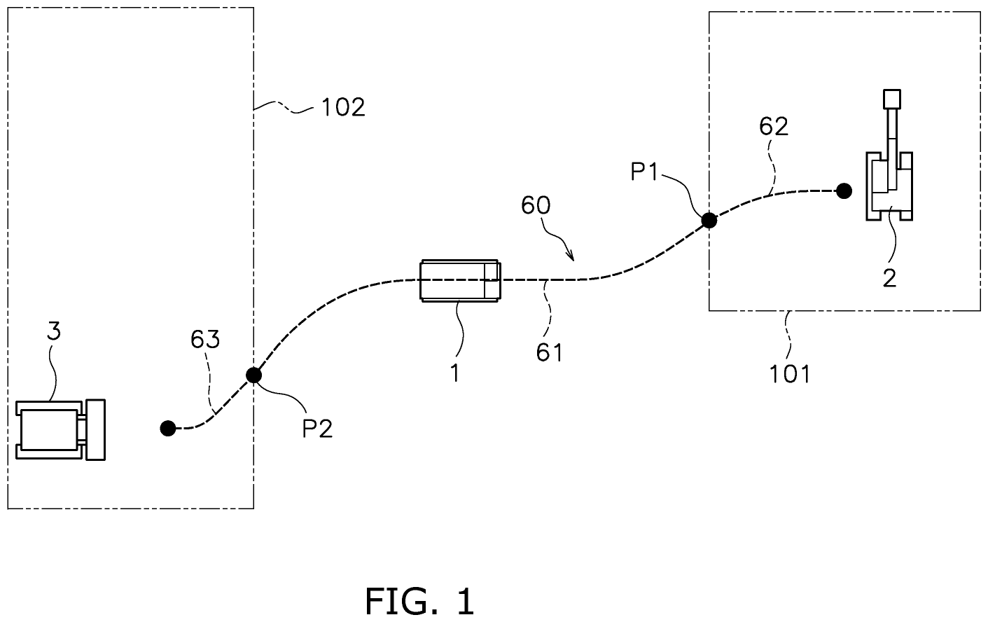

Hereinafter, a control system of a transport vehicle according to an embodiment will be described with reference to the drawings. FIG. 1 is a plan view illustrating an example of a work site where a transport vehicle 1 is used. The transport vehicle 1, a first work machine 2, and a second work machine 3 are disposed at the work site. In the present embodiment, the first work machine 2 is a hydraulic excavator. The transport vehicle 1 is a dump truck. The second work machine 3 is a bulldozer.

The first work machine 2 is disposed in a first work area 101 in the work site. The second work machine 3 is disposed in a second work area 102 in the work site. The first work machine 2 digs in the first work area 101 and loads the dug materials, such as soil and the like, onto the transport vehicle 1. The transport vehicle 1 moves from the first work area 101 to the second work area 102 and dumps the materials in the second work area 102. The second work machine 3 spreads and levels the dumped materials in the second work area 102. After dumping the materials, the transport vehicle 1 returns from the second work area 102 to the first work area 101. The transport vehicle 1 travels back and forth between the first work area 101 and the second work area 102 in the work site. The materials in the first work area 101 are transported to the second work area 102 by repeating the above work.

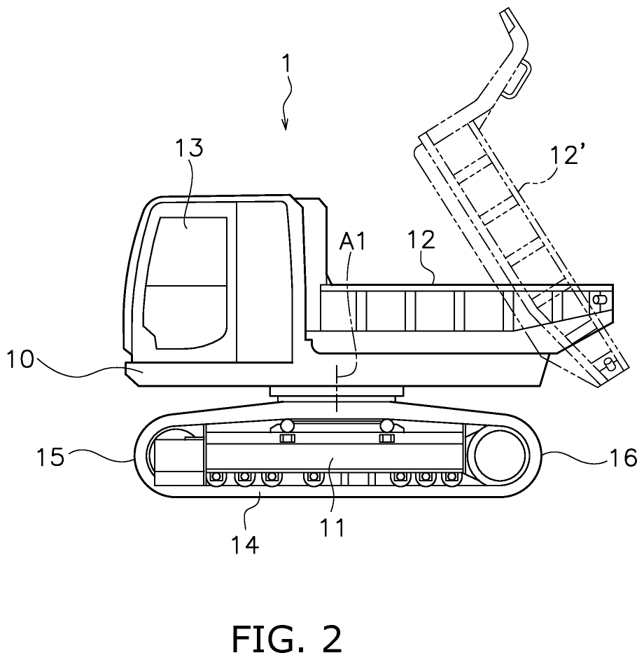

FIG. 2 is a side view of the transport vehicle 1. As illustrated in FIG. 2, the transport vehicle 1 includes a vehicle body 10, a traveling body 11, and a bed 12. The vehicle body 10 is supported by the traveling body 11. The vehicle body 10 is rotatable around a rotation axis Al with respect to the traveling body 11. The vehicle body 10 includes an operating cabin 13. The traveling body 11 includes crawler belts 14. The transport vehicle 1 travels due to the rotation of the crawler belts 14. The traveling body 11 includes a first traveling body portion 15 and a second traveling body portion 16. The first traveling body portion 15 and the second traveling body portion 16 are positioned opposite to each other in a traveling direction of the transport vehicle 1. The first traveling body portion 15 is one end portion in the front-back direction of the traveling body 11 and the second traveling body portion 16 is the other end portion in the front-back direction of the traveling body 11.

The bed 12 is supported by the vehicle body 10. The bed 12 is configured to move between a dumping posture and a transporting posture. In FIG. 2, the bed 12 indicated by the solid lines represents a position of the bed 12 in the transporting posture. The bed 12′ indicated by the chain double-dashed lines represents a position of the bed 12 in the dumping posture. In the transporting posture, the bed 12 is disposed approximately horizontally. In the dumping posture, the bed 12 is tilted with respect to the transporting posture.

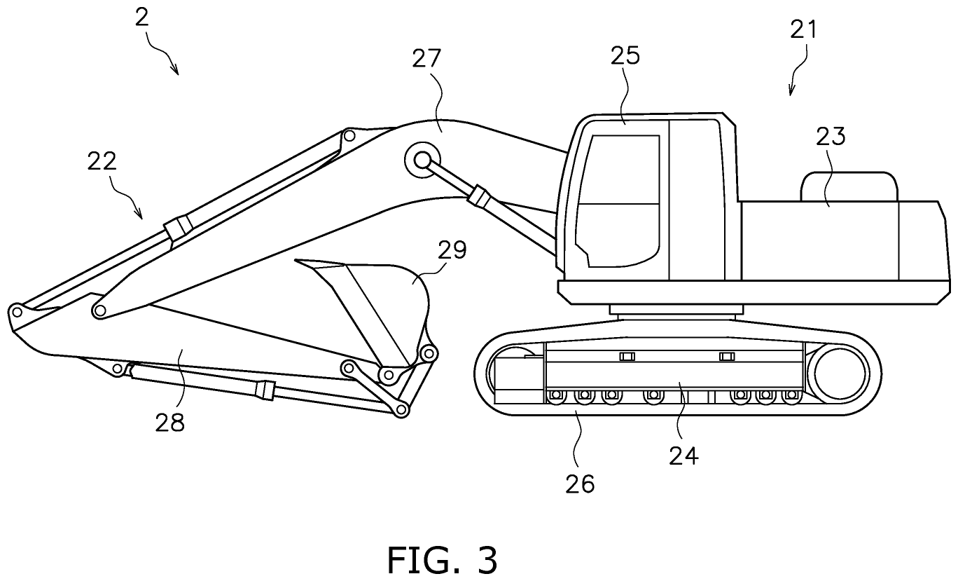

FIG. 3 is a side view of the first work machine 2. As illustrated in FIG. 3, the first work machine 2 includes a vehicle body 21 and a work implement 22. The vehicle body 21 includes a rotating body 23 and a traveling body 24. The rotating body 23 is rotatably attached to the traveling body 24. An operating cabin 25 is disposed on the rotating body 23. The traveling body 24 includes crawler belts 26. The first work machine 2 travels due to the rotation of the crawler belts 26.

The work implement 22 is attached to the front part of the vehicle body 21. The work implement 22 includes a boom 27, an arm 28, and a bucket 29. The boom 27 is attached to the rotating body 23 so as to be movable up and down. The arm 28 is movably attached to the boom 27. The bucket 29 is movably attached to the arm 28. Hydraulic cylinders are attached to the boom 27, the arm 28, and the bucket 29. Due to the extension and contraction of the hydraulic cylinders, the work implement 22 operates.

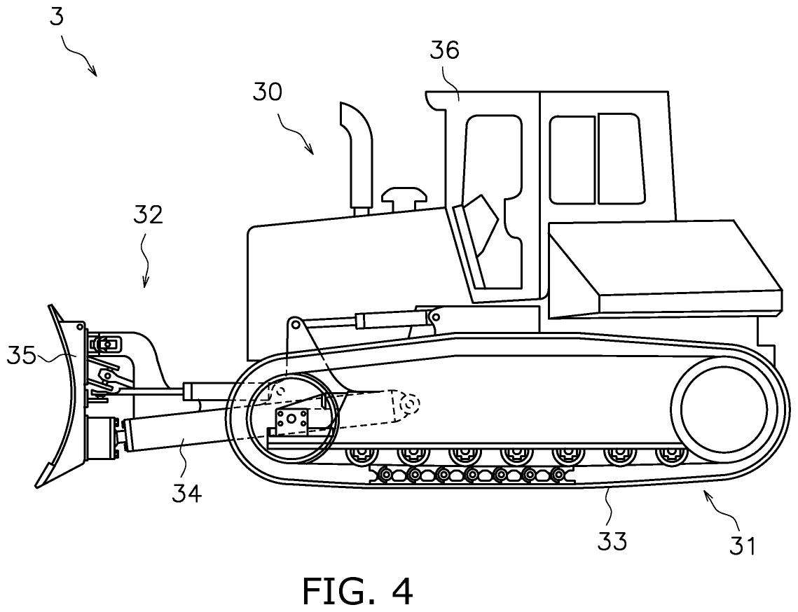

FIG. 4 is a side view of the second work machine 3. As illustrated in FIG. 4, the second work machine 3 includes a vehicle body 30, a traveling body 31, and a work implement 32. The vehicle body 30 includes an operating cabin 36. The vehicle body 30 is supported by the traveling body 31. The traveling body 31 includes crawler belts 33. The second work machine 3 travels due to the rotation of the crawler belts 33.

The work implement 32 is attached to the vehicle body 30. The work implement 32 includes a lift frame 34 and a blade 35. The lift frame 34 is attached to the vehicle body 30 so as to be movable up and down. The lift frame 34 supports the blade 35. The blade 35 moves up and down accompanying the up and down movements of the lift frame 34. A hydraulic cylinder is attached to the lift frame 34. Due to the extension and contraction of the hydraulic cylinder, the work implement 32 moves up and down.

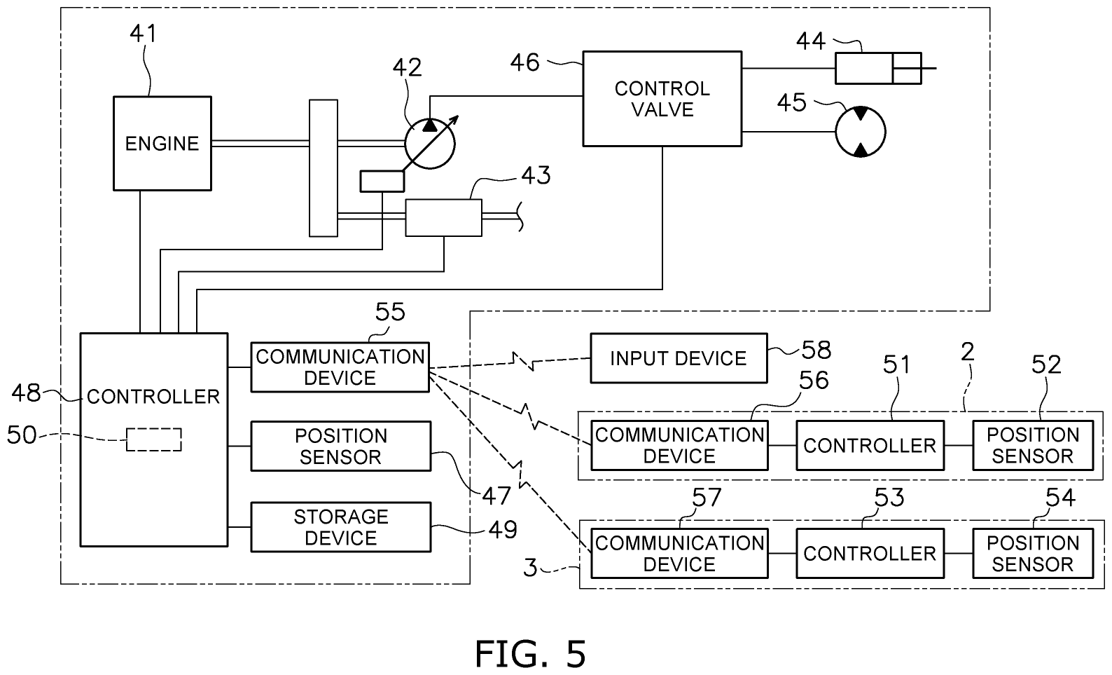

FIG. 5 is a block diagram illustrating a configuration of a control system of the transport vehicle 1. The transport vehicle 1 includes an engine 41, a hydraulic pump 42, a power transmission device 43, a lift cylinder 44, a rotation motor 45, and a control valve 46.

The hydraulic pump 42 is driven by the engine 41 to discharge hydraulic fluid. Although one hydraulic pump 42 is illustrated in FIG. 5, a plurality of hydraulic pumps may be included. The control valve 46 is disposed between the lift cylinder 44 and the hydraulic pump 42 and between the rotation motor 45 and the hydraulic pump 42. The control valve 46 controls the flow rate of the hydraulic fluid supplied from the hydraulic pump 42 to the lift cylinder 44. The control valve 46 may be a pressure proportional control valve. Alternatively, the control valve 46 may be an electromagnetic proportional control valve.

The power transmission device 43 transmits driving force of the engine 41 to the traveling body 11. The power transmission device 43 is, for example, a hydro static transmission (HST).

The lift cylinder 44 is a hydraulic cylinder. The rotation motor 45 is a hydraulic motor. The hydraulic fluid discharged from the hydraulic pump 42 is supplied to the lift cylinder 44 and the rotation motor 45. The lift cylinder 44 and the rotation motor 45 are driven by the hydraulic fluid from the hydraulic pump 42. The lift cylinder 44 raises and lowers the bed 12. Consequently, the posture of the bed 12 is switched between the transporting posture and the dumping posture. The rotation motor 45 rotates the vehicle body 10 with respect to the traveling body 11. The controller 48 controls the lift cylinder 44 by means of the control valve 46, thereby controlling the operation of the bed 12. In addition, the controller 48 controls the rotation motor 45 by means of the control valve 46, thereby controlling the rotation of the vehicle body 10.

The transport vehicle 1 includes a position sensor 47. The position sensor 47 includes, for example, a global navigation satellite system (GNSS) receiver and an inertial measurement unit (IMU). The position sensor 47 detects a position of the transport vehicle 1 and an orientation of the vehicle body 10 to output position data. The position data includes data indicative of the position of the transport vehicle 1 and data indicative of the orientation of the vehicle body 10.

The transport vehicle 1 includes a controller 48 and a storage device 49. The controller 48 includes a processor 50, such as a CPU or a GPU. The processor 50 executes processes for automatic control of the transport vehicle 1. The storage device 49 includes a memory, such as a RAM or a ROM, and an auxiliary storage device, such as a hard disk drive (HDD) or a solid state drive (SSD). The storage device 49 stores data and programs for the automatic control of the transport vehicle 1.

The controller 48 is communicably connected to the position sensor 47 and the storage device 49 by wire or wirelessly. The controller 48 receives the position data from the position sensor 47. The controller 48 is programmed to control the transport vehicle 1 based on acquired data. The controller 48 controls the engine 41, the traveling body 11, and the power transmission device 43, thereby causing the transport vehicle 1 to travel. The controller 48 controls the engine 41, the hydraulic pump 42, and the control valve 46, thereby causing the bed 12 to operate. The controller 48 controls the engine 41, the hydraulic pump 42, and the control valve 46, thereby rotating the vehicle body 10 with respect to the traveling body 11.

As illustrated in FIG. 5, the first work machine 2 includes a controller 51 and a position sensor 52. The second work machine 3 includes a controller 53 and a position sensor 54. The controllers 51 and 53 and the position sensors 52 and 54 have the same configurations as the controller 48 and the position sensor 47 of the transport vehicle 1, respectively. The position sensor 52 of the first work machine 2 outputs data indicative of a position and an orientation of the first work machine 2. The position sensor 54 of the second work machine 3 outputs data indicative of a position and an orientation of the second work machine 3.

The transport vehicle 1 includes a communication device 55. The first work machine 2 includes a communication device 56. The second work machine 3 includes a communication device 57. The communication devices 55 to 57 perform data communication with each other via a communication network, such as a wireless LAN or a mobile communication network. The controller 48 of the transport vehicle 1 performs data communication with the controller 51 of the first work machine 2 via the communication device 55. The controller 48 of the transport vehicle 1 performs data communication with the controller 53 of the second work machine 3 via the communication device 55.

The controller 48 of the transport vehicle 1 performs data communication with an input device 58 via the communication device 55. The input device 58 includes a pointing device such as a mouse and a keyboard. Alternatively, the input device 58 may include a touch screen. The input device 58 is operable by an operator. The input device 58 transmits a signal indicative of an operation input by the operator to the controller 48. The input device 58 may be disposed outside of the transport vehicle 1. Alternatively, the input device 58 may be disposed in the transport vehicle 1.

Next, processes of automatic control executed by the controller 48 of the transport vehicle 1 will be described. As illustrated in FIG. 1, the controller 48 determines a travel path 60 indicative of a target route of the transport vehicle 1. The controller 48 causes the transport vehicle 1 to automatically travel according to the travel path 60 illustrated in FIG. 1. The travel path 60 includes a static path 61, a first dynamic path 62, and a second dynamic path 63.

The static path 61 is positioned between the first work area 101 and the second work area 102. The static path 61 is determined regardless of work of the first work machine 2 and the second work machine 3. The first dynamic path 62 indicates a target route of the transport vehicle 1 in the first work area 101. The first dynamic path 62 is changed according to work of the first work machine 2. The second dynamic path 63 indicates a target route of the transport vehicle 1 in the second work area 102. The second dynamic path 63 is changed according to work of the second work machine 3.

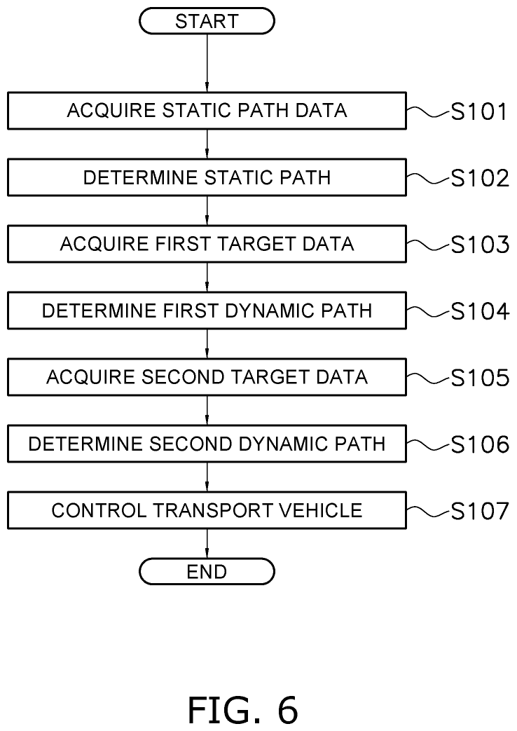

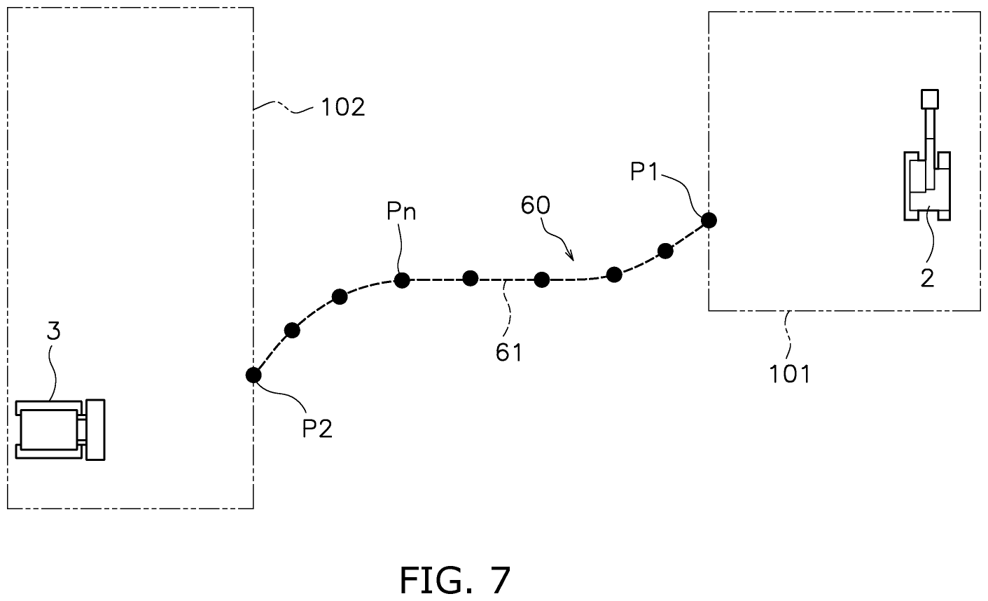

FIG. 6 is a flowchart illustrating processes of automatic control executed by the controller 48. In step S101, the controller 48 acquires static path data. The static path data indicates a position of the static path 61. As illustrated in FIG. 7, the static path data includes coordinates of a first endpoint P1, a second endpoint P2 and a plurality of points Pn (n=3, 4, 5, . . . ) between the first endpoint P1 and the second endpoint P2. In FIG. 7, a reference sign Pn is given to only one of the plurality of points, while other reference signs Pn are omitted.

The first endpoint P1 is an endpoint of the static path 61 at a side of the first work area 101. The second endpoint P2 is an endpoint of the static path 61 at a side of the second work area 102. When the transport vehicle 1 moves from the first work area 101 toward the second work area 102 (hereinafter referred to as an “approach route”), the first endpoint P1 is a starting point of the static path 61 and the second endpoint P2 is an ending point of the static path 61. When the transport vehicle 1 moves from the second work area 102 toward the first work area 101 (hereinafter referred to as a “return route”), the second endpoint P2 is a starting point of the static path 61 and the first endpoint P1 is an ending point of the static path 61.

The static path data is preset and stored in the storage device 49. The controller 48 may acquire the static path data from an external computer via a communication network. Alternatively, the controller 48 may acquire the static path data via a recording medium. Alternatively, the controller 48 may generate the static path data by the operator designating the static path 61 with the input device 58.

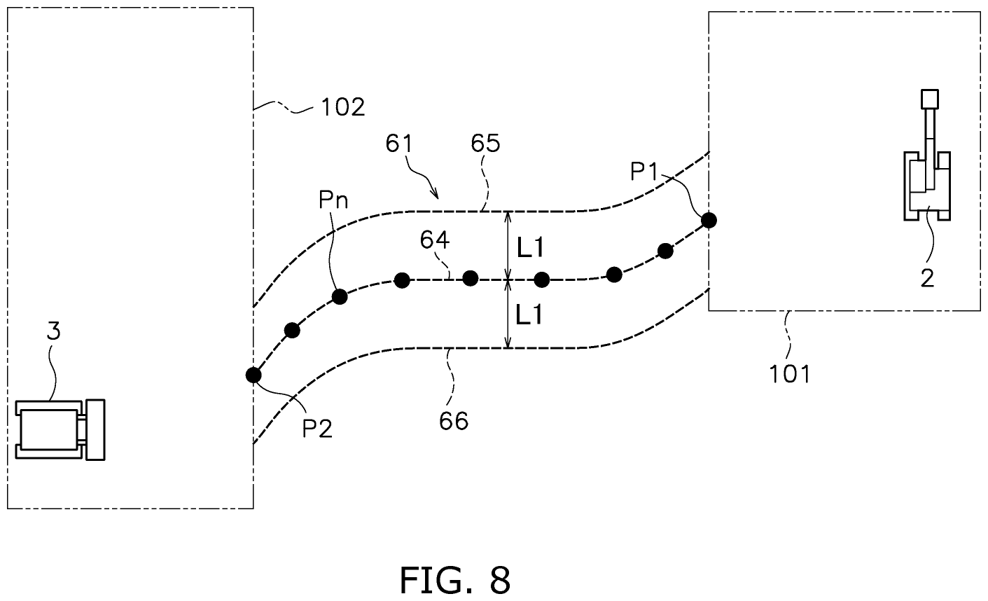

In step S102, the controller 48 determines the static path 61. As illustrated in FIG. 8, the controller 48 determines a route indicated by the static path data as a first route 64. The controller 48 determines a second route 65 in which the first route 64 is offset by a predetermined distance L1 in the left-right direction of the transport vehicle 1. Further, the controller 48 determines a third route 66 in which the first route 64 is offset by the predetermined distance L1 in the direction opposite to the second route 65. The controller 48 calculates the predetermined distance L1 by the following formula (1), for example.

L1=(H−B−D)/2−M (1)

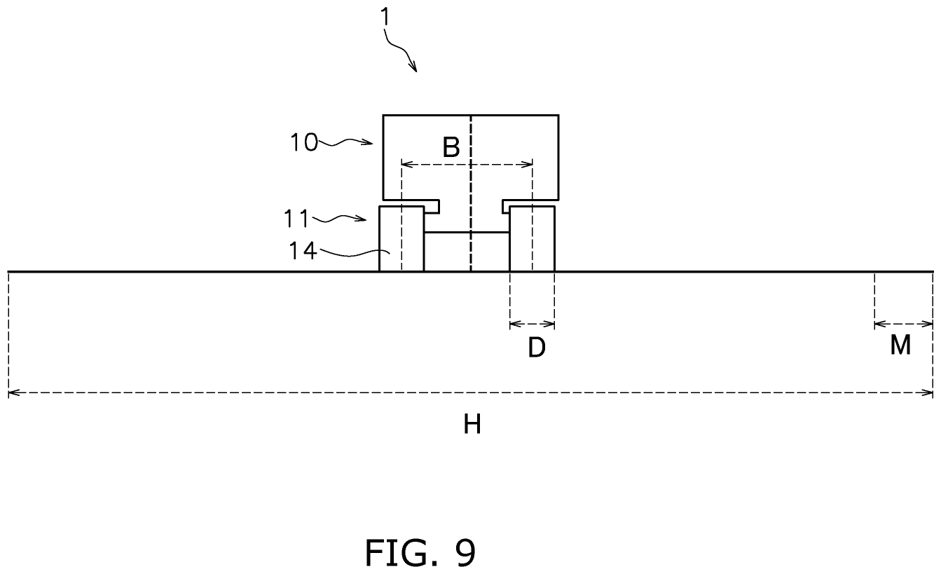

FIG. 9 is a front view of the transport vehicle 1 and a traveling area of the transport vehicle 1. As illustrated in FIG. 9, H represents the width of the traveling area of the transport vehicle 1 and is defined according to the work site. B represents the width of the gauge of the transport vehicle 1. D represents the width of the crawler belt. M represents a margin.

The controller 48 switches between the first route 64, the second route 65, and the third route 66 to determine the static path 61. For example, the controller 48 may determine the first route 64 as the static path 61 for an approach route and determine the second route 65 as the static path 61 for a return route. The controller 48 may determine the third route 66 as the static path 61 for a next approach route and determine the first route 64 as the static path 61 for a next return route. Alternatively, the controller 48 may switch the static path 61 between the first route 64, the second route 65, and the third route 66 for each reciprocating travel. Alternatively, the controller 48 may switch the static path 61 to any one of the first route 64, the second route 65, or the third route 66 according to the operation of the input device 58 by the operator.

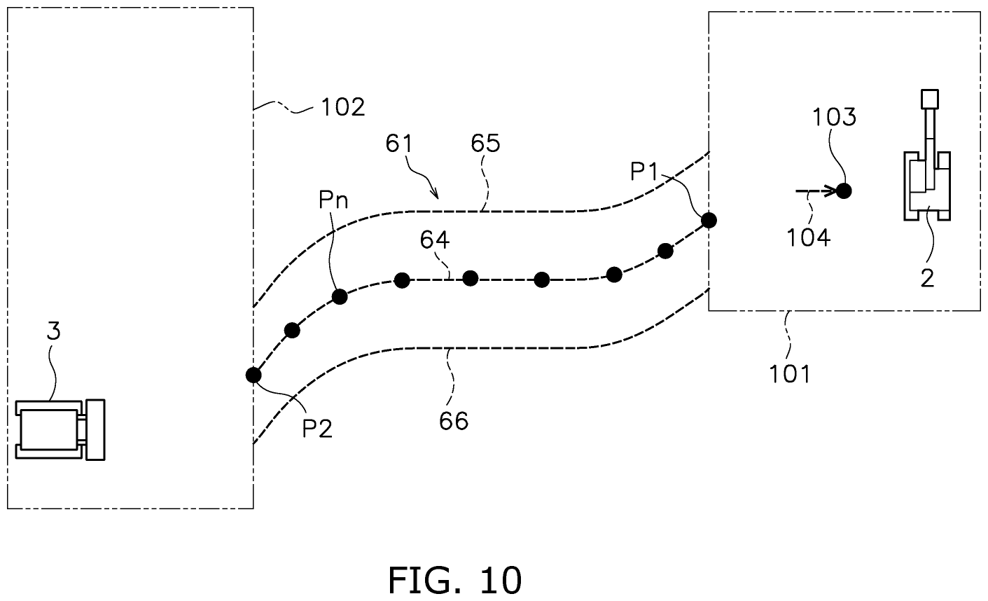

In step S103, the controller 48 acquires first target data. The controller 48 acquires the first target data from the controller 51 of the first work machine 2 by communication. As illustrated in FIG. 10, the first target data includes the coordinates of a first target position 103 in the first work area 101 and a first target orientation 104 of the transport vehicle 1 at the first target position 103. The first target position 103 is a target stop position of the transport vehicle 1 in the first work area 101. The first work machine 2 loads the materials onto the transport vehicle 1 at the first target position 103. The first target data is changed according to work of the first work machine 2. The controller 51 of the first work machine 2 determines the first target data according to the position and orientation of the first work machine 2. For example, the controller 51 of the first work machine 2 determines the first target data so that the transport vehicle 1 faces the front surface or the side surface of the vehicle body 21 of the first work machine 2.

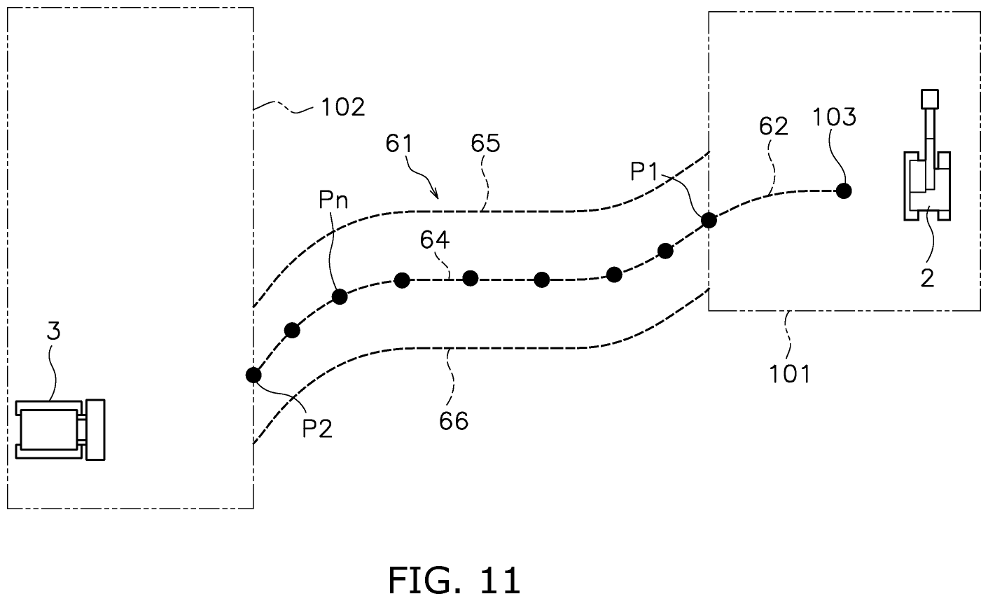

In step S104, the controller 48 determines the first dynamic path 62. As illustrated in FIG. 11, the controller 48 determines, as the first dynamic path 62, a route that connects the first endpoint P1 and the first target position 103. The controller 48 determines the first dynamic path 62 according to the first target orientation 104 of the transport vehicle 1.

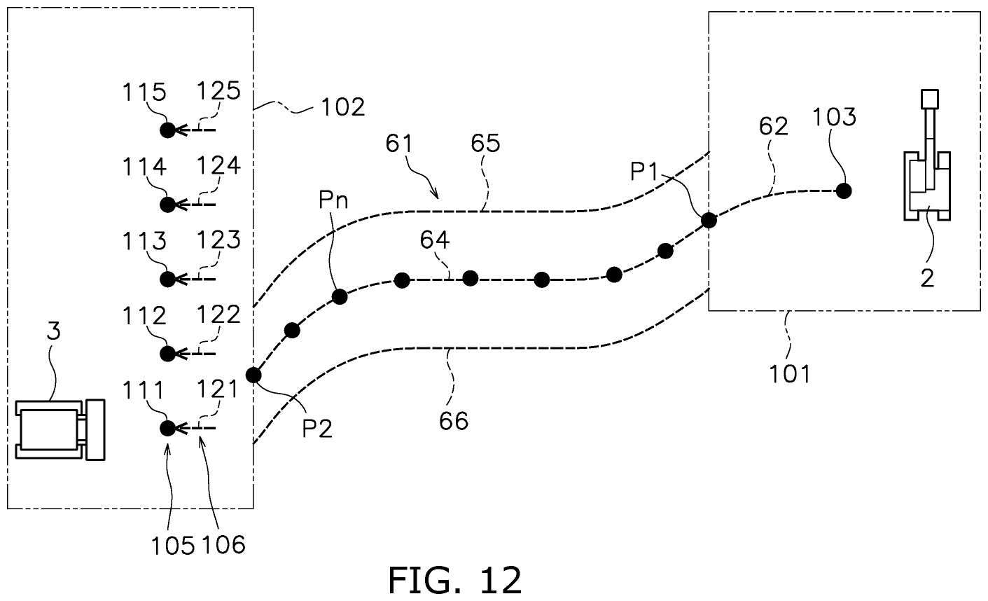

In step S105, the controller 48 acquires second target data. The controller 48 acquires the second target data from the controller 53 of the second work machine 3 by communication. The second target data includes the coordinates of a second target position 105 and a second target orientation 106 of the transport vehicle 1 at the second target position 105. The second target position 105 is a target stop position of the transport vehicle 1 in the second work area 102. The second work machine 3 spreads and levels the materials dumped at the second target position 105. The second target data is changed according to work of the second work machine 3. As illustrated in FIG. 12, the second target data includes the coordinates of a plurality of target points 111 to 115 that are preset and second target orientations 121 to 125 at the respective target points 111 to 115. The plurality of target points 111 to 115 are disposed apart from each other at a predetermined interval in the second work area 102. The controller 48 determines, as the second target position 105, a target point designated by the controller 53 of the second work machine 3 among the plurality of target points 111 to 115. Alternatively, the controller 48 may determine, as the second target position 105, a target point among the plurality of target points 111 to 115 in order.

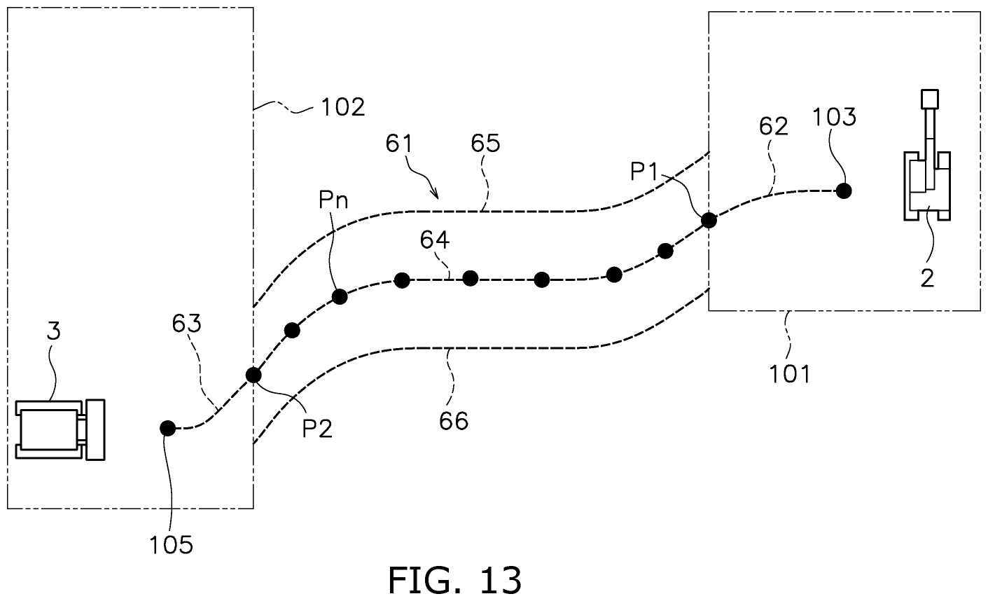

In step S106, the controller 48 determines the second dynamic path 63. As illustrated in FIG. 13, the controller 48 determines, as the second dynamic path 63, a route that connects the second endpoint P2 and the second target position 105. The controller 48 determines the second dynamic path 63 according to the second target orientation 106 of the transport vehicle 1.

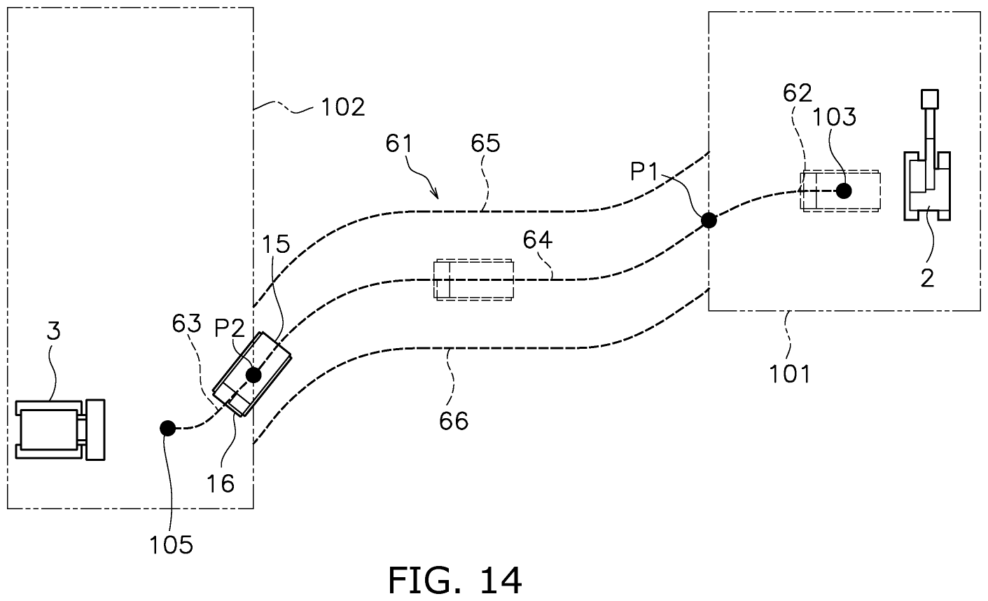

In step S107, the controller 48 controls the transport vehicle 1. The controller 48 controls the transport vehicle 1 so that the transport vehicle 1 travels according to the above-mentioned first dynamic path 62, the static path 61, and the second dynamic path 63. After the static path 61 is determined, the controller 48 may control the transport vehicle 1 so that the transport vehicle 1 starts traveling even before determining the first dynamic path 62 or the second dynamic path 63. FIG. 14 illustrates the transport vehicle 1 when moving from the first work area 101 to the second work area 102. As illustrated in FIG. 14, after loaded with the materials at the first target position 103, the transport vehicle 1 moves from the first target position 103 through the first dynamic path 62 and the static path 61 to the second endpoint P2. During this time, the transport vehicle 1 travels on the static path 61 toward the second work area 102 with the second traveling body portion 16 facing front.

The controller 48 determines whether an entry into the second dynamic path 63 is allowed at the second endpoint P2. For example, when the second target data is appropriately acquired from the second work machine 3, the controller 48 determines that the entry into the second dynamic path 63 is allowed. When the second target data is not appropriately acquired from the second work machine 3, the controller 48 determines that the entry into the second dynamic path 63 is not allowed. When the controller 48 determines that the entry into the second dynamic path 63 is not allowed, the controller 48 causes the transport vehicle 1 to wait on standby at the second endpoint P2 until the second target data is appropriately acquired from the second work machine 3.

The controller 48 may determine whether the entry into the second dynamic path 63 is allowed at a position other than the second endpoint P2. For example, the controller 48 may determine whether the entry into the second dynamic path 63 is allowed at the first target position 103. Alternatively, the controller 48 may determine whether the entry into the second dynamic path 63 is allowed while the transport vehicle 1 travels on the first dynamic path 62 or the static path 61.

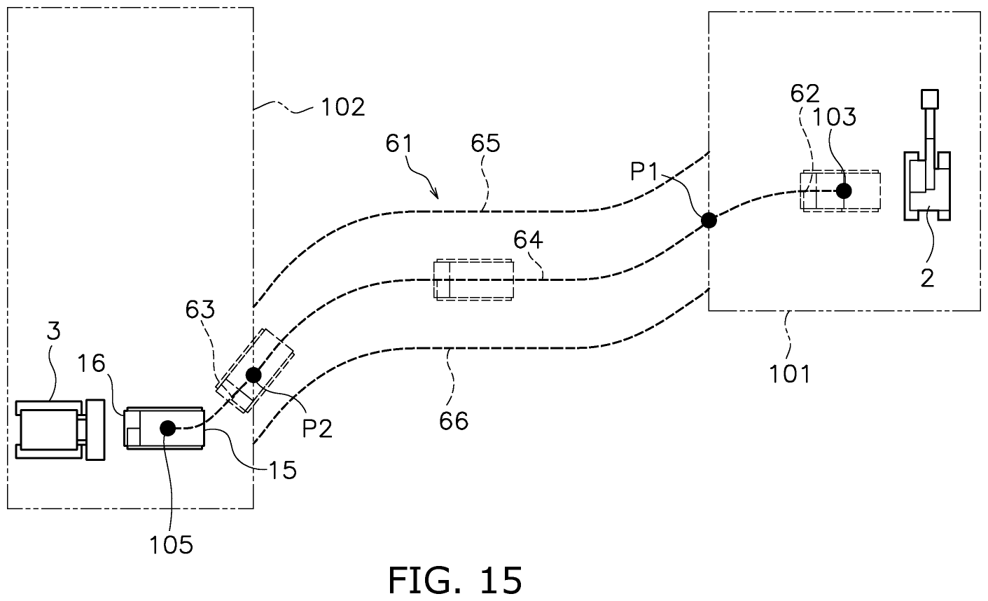

When the second target data is appropriately acquired from the second work machine 3, the controller 48 causes the transport vehicle 1 to travel according to the second dynamic path 63 and stop at the second target position 105 as illustrated in FIG. 15. At this time, the controller 48 causes the transport vehicle 1 to arrive at the second target position 105 with the second traveling body portion 16 facing front. The controller 48 rotates the vehicle body 10 with respect to the traveling body 11 to switch between the front part and the rear part of the vehicle body 10. Then, the controller 48 switches the bed 12 to the dumping posture, whereby the materials are dumped from the bed 12.

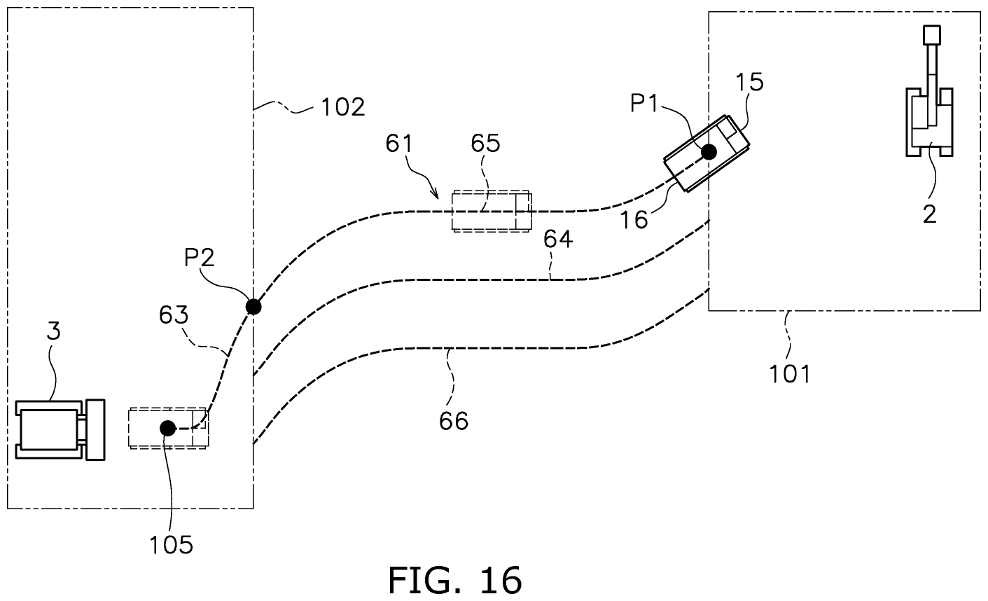

FIG. 16 illustrates the transport vehicle 1 when moving from the second work area 102 to the first work area 101. As illustrated in FIG. 16, when the transport vehicle 1 moves away from the second target position 105, the transport vehicle 1 travels with the first traveling body portion 15 facing front. As illustrated in FIG. 16, after dumping the materials at the second target position 105, the transport vehicle 1 moves from the second target position 105 through the second dynamic path 63 and the static path 61 to the first endpoint P1. During this time, the transport vehicle 1 travels on the static path 61 toward the first work area 101 with the first traveling body portion 15 facing front.

In the example illustrated in FIG. 16, the controller 48 determines the static path 61 for the return route that is different from the one for the approach route. For example, the controller 48 determines the second route 65 as the static path 61 for the return route. In this case, the controller 48 determines, as the second dynamic path 63, a route that connects the second endpoint P2 of the second route 65 and the second target position 105.

The controller 48 determines whether an entry into the first dynamic path 62 is allowed at the first endpoint P1. For example, when the first target data is appropriately acquired from the first work machine 2, the controller 48 determines that the entry into the first work area 101 is allowed. When the first target data is not appropriately acquired from the first work machine 2, the controller 48 determines that the entry into the first work area 101 is not allowed. When the controller 48 determines that the entry into the first work area 101 is not allowed, the controller 48 causes the transport vehicle 1 to wait on standby at the first endpoint P1 until the first target data is appropriately acquired from the first work machine 2.

The controller 48 may determine whether the entry into the first dynamic path 62 is allowed at a position other than the first endpoint P1. For example, the controller 48 may determine whether the entry into the first dynamic path 62 is allowed at the second target position 105. Alternatively, the controller 48 may determine whether the entry into the first dynamic path 62 is allowed while the transport vehicle 1 travels on the second dynamic path 63 or the static path 61.

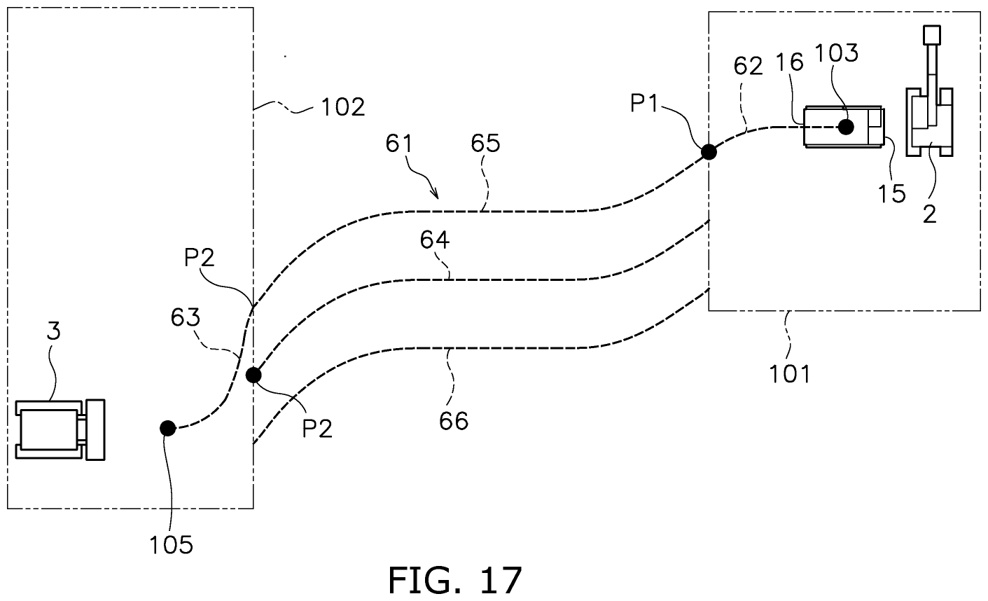

When the first target data is appropriately acquired from the first work machine 2, the controller 48 determines, as the first dynamic path 62, a route that connects the first endpoint P1 and the first target position 103 as illustrated in FIG. 17. At this time, when the first target position 103 is changed, the controller 48 determines, as the first dynamic path 62, a route that connects the changed first target position 103 and the first endpoint P1. The controller 48 causes the transport vehicle 1 to travel according to the first dynamic path 62 and stop at the first target position 103. At this time, the controller 48 causes the transport vehicle 1 to arrive at the first target position 103 with the first traveling body portion 15 facing front. The controller 48 rotates the vehicle body 10 with respect to the traveling body 11 to switch the front part and the rear part of the vehicle body 10. Then, the first work machine 2 loads the materials onto the bed 12 of the transport vehicle 1. The controller 48 repeatedly executes the above processes.

In the control system of the transport vehicle 1 according to the present embodiment described above, the first dynamic path 62 is determined according to the first target position 103 for work of the first work machine 2. The second dynamic path 63 is determined according to the second target position 105 for work of the second work machine 3. Accordingly, the optimal travel path 60 of the transport vehicle 1 can be determined.

Although an embodiment of the present invention has been described so far, the present invention is not limited to the above embodiment and various modifications can be made without departing from the gist of the invention.

The first work machine 2 is not limited to the hydraulic excavator and may be another machine, such as a wheel loader. The second work machine 3 is not limited to the bulldozer and may be another machine, such as a motor grader. The configurations of the first work machine 2 and/or the second work machine 3 are not limited to those of the above embodiment and may be changed. For example, the first work machine 2 and/or the second work machine 3 may be a vehicle driven by an electric motor. The operating cabin 25 of the first work machine 2 and/or the operating cabin 36 of the second work machine 3 may be omitted. The configurations of the work implements 22 and 32 are not limited to those of the above-mentioned embodiment and may be changed. The first work machine 2 and/or the second work machine 3 may be manually operated by an operator, instead of the automatic control.

The transport vehicle 1 may be a vehicle other than the dump truck. The configuration of the transport vehicle 1 is not limited to that of the above embodiment and may be changed. For example, the transport vehicle 1 may be a vehicle driven by an electric motor. The traveling body 11 and/or the bed 12 may be driven by an electric motor. The bed 12 of the transport vehicle 1 may not be rotatable. The traveling body 11 of the transport vehicle 1 may include tires instead of the crawler belts 14. The power transmission device 43 is not limited to the HST and may be another type of power transmission device, such as a transmission having a torque converter or a plurality of transmission gears. The operating cabin 13 of the transport vehicle 1 may be omitted.

The controller 48 is not limited to one unit and may be divided into a plurality of controllers. The processes executed by the controller 48 may be distributed and executed among the plurality of controllers. In that case, a portion of the plurality of controllers 48 may be disposed outside of the transport vehicle 1.

The controller 51 of the first work machine 2 and the controller 48 of the transport vehicle 1 may communicate with each other via another controller, instead of directly communicating with each other. The controller 53 of the second work machine 3 and the controller 48 of the transport vehicle 1 may communicate with each other via another controller, instead of directly communicating with each other.

The processes of the automatic control mode executed by the controller 48 are not limited to those of the above embodiment and may be changed. For example, the processes for causing the transport vehicle 1 to wait on standby at the first endpoint P1 or the second endpoint P2 may be omitted. The control for causing the transport vehicle 1 to wait on standby at the first endpoint P1 or the second endpoint P2 may be switched on and off. The controller 48 may determine whether the entry into the first work area 101 or the second work area 102 is allowed corresponding to a signal from the input device 58.

The number of the routes of the static path 61 is not limited to three and may be less than three or greater than three. The processes for determining the first target position 103 may be changed. The processes for determining the second target position 105 may be changed. For example, the controller 53 of the second work machine 3 may determine the second target position 105 according to the position and orientation of the second work machine 3 in the same manner as the processes for determining the first target position 103. The number of the plurality of target points for the second target position is not limited to five and may be less than five or greater than five.

According to the present disclosure, the optimal target route can be determined.

1. A system for controlling a transport vehicle that transports materials between a first work machine and a second work machine; the system comprising:
a storage device; and
a controller connected to the storage device,
the controller being configured to
acquire a static path, the static path being set between the first work machine and the second work machine, including a first endpoint and a second endpoint, and being indicative of a target route of the transport vehicle,
acquire a first target position for work of the first work machine,
determine a first dynamic path that connects the first endpoint and the first target position,
acquire a second target position for work of the second work machine,
determine a second dynamic path that connects the second endpoint and the second target position, and
control the transport vehicle so that the transport vehicle travels according to the static path, the first dynamic path, and the second dynamic path.

2. The system according to claim 1, wherein
the first target position is changed according to the work of the first work machine.

3. The system according to claim 2, wherein
the controller is configured to acquire the first target position from the first work machine.

4. The system according to claim 2, wherein
the controller is configured to
acquire a target orientation of the transport vehicle at the first target position, and
determine the first dynamic path according to the target orientation.

5. The system according to claim 2, wherein
the controller is configured to
determine whether an entry into the first dynamic path is allowed, and
when it is determined that the entry into the first dynamic path is not allowed, cause the transport vehicle to wait on standby at the first endpoint.

6. The system according to claim 1, wherein
the second target position is changed according to the work of the second work machine.

7. The system according to claim 1, wherein
the controller is configured to
acquire a plurality of target points that are preset, and
determine, as the second target position, a target point selected from the plurality of target points.

8. The system according to claim 6, wherein
the controller is configured to
determine whether an entry into the second dynamic path is allowed, and
when it is determined that the entry into the second dynamic path is not allowed, cause the transport vehicle to wait on standby at the second endpoint.

9. The system according to claim 1, wherein
the controller is configured to
acquire a first route that is determined regardless of the work of the first work machine and the second work machine,
acquire a second route in which the first route is offset by a predetermined distance in a width direction of the first route, and
switch between the first route and the second route to determine the static path.

10. The system according to claim 2, wherein
the transport vehicle includes a first traveling body portion and a second traveling body portion that are positioned opposite to each other in a traveling direction of the transport vehicle, and
the controller is configured to
when the transport vehicle travels on the static path toward the first dynamic path with the first traveling body portion facing front, cause the transport vehicle to arrive at the first target position with the first traveling body portion facing front, and
when the transport vehicle moves away from the first target position, cause the transport vehicle to travel with the second traveling body portion facing front.

11. The system according to claim 6, wherein
the transport vehicle includes a first traveling body portion and a second traveling body portion that are positioned opposite to each other in a traveling direction of the transport vehicle, and
the controller is configured to
when the transport vehicle travels on the static path toward the second dynamic path with the second traveling body portion facing front, cause the transport vehicle to arrive at the second target position with the second traveling body portion facing front, and
when the transport vehicle moves away from the second target position, cause the transport vehicle to travel with the first traveling body portion facing front.

12. A method executed by a controller for controlling a transport vehicle that transports materials between a first work machine and a second work machine, the method comprising:
acquiring a static path, the static path being set between the first work machine and the second work machine, including a first endpoint and a second endpoint, and being indicative of a target route of the transport vehicle;
acquiring a first target position for work of the first work machine;
determining a first dynamic path that connects the first endpoint and the first target position;
acquiring a second target position for work of the second work machine;
determining a second dynamic path that connects the second endpoint and the second target position; and
controlling the transport vehicle so that the transport vehicle travels according to the static path, the first dynamic path, and the second dynamic path.

13. The method according to claim 12, wherein
the first target position is changed according to the work of the first work machine.

14. The method according to claim 13, wherein
the first target position is acquired from the first work machine.

15. The method according to claim 13, further comprising
acquiring a target orientation of the transport vehicle at the first target position; and
determining the first dynamic path according to the target orientation.

16. The method according to claim 13, further comprising
determining whether an entry into the first dynamic path is allowed; and
when it is determined that the entry into the first dynamic path is not allowed, causing the transport vehicle to wait on standby at the first endpoint.

17. The method according to claim 12, wherein
the second target position is changed according to the work of the second work machine.

18. The method according to claim 12, further comprising
acquiring a plurality of target points that are preset,
a target point selected from the plurality of target points being determined as the second target position.

19. The method of claim 17, further comprising
determining whether an entry into the second dynamic path is allowed; and
when it is determined that the entry into the second dynamic path is not allowed, causing the transport vehicle to wait on standby at the second endpoint.

20. The method according to claim 12, further comprising
acquiring a first route that is determined regardless of the work of the first work machine and the second work machine;
acquiring a second route in which the first route is offset by a predetermined distance in a width direction of the first route; and
switching between the first route and the second route to determine the static path.
